(19) United States
(12) Patent Application Publication
(10) Pub. No.: US 2014/0338236 A1
(43) Pub. Date: Nov. 20, 2014

(54) PERSONALIZED SOCIAL EXPRESSION METHOD AND APPARATUS

(71) Applicant: Kathleen Horton Koehnemann, Panama City, FL (US)

(72) Inventor: Kathleen Horton Koehnemann, Panama City, FL (US)

(21) Appl. No.: 14/277,376

(22) Filed: May 14, 2014

Related U.S. Application Data
(60) Provisional application No. 61/823,745, filed on May 15, 2013.

(51) Int. Cl. B42D 15/02

(52) U.S. Cl. CPC B42D 15/02
USPC 40/124.01

(57) ABSTRACT

Methods for providing personalized social expression items such as a greeting card, a note card and a photo card, allow consumers to mix and match a visual artwork with an appropriate message that is suitable for a particular occasion, and provide consumers with the freedom to affix the selected message on any desired location on the visual artwork. The methods provide consumers with options to choose the type of social expression item, choose the visual artwork to be incorporated into the social expression item and choose the appropriate message to be included in the social expression item. The message is imprinted on a self-adhesive label instead of on the social expression item. The consumers can then place the label containing the desired message on any desired location on the visual artwork and mail the social expression item to the intended recipient.

This application claims priority to and incorporates herein by reference the U.S. Provisional Patent Application Ser. No. 61/823,745 filed on May 15, 2013 entitled “Purpose a Passage.”

### BACKGROUND OF THE INVENTION

1. Field of the Invention

This invention relates generally to the method for providing personalized social expression items, including greeting cards, photo cards, postcards, note cards, matted photo images and other stationery items.

2. Description of Prior Art and Related Information

Commercially available social expression items, such as greeting cards, post cards and photo cards, typically include visual artworks and generic messages of sentiment by the fact that they are “tailored” for an occasion by a writer who is emotionally detached from the actual event and from the individuals to whom the greeting is intended. A greeting card for a person who is grieving over a loss of a family member, for example, may include a dramatic photo image on the outer portion of the card and a particular message of condolences on the inside of the card to express the sympathies of the sender. However, mass produced commercial greeting cards often fail to capture and express the true feelings of the senders of the cards. No one knows what an individual is feeling or how best to express their sentiment better than the individual them-self, so buying a manufactured idea that is preprinted on a card is, at best, inadequate. It may get the job done of sending a card, but it does not fulfill or satisfy either the sender or the recipient. In other instances, a commercial greeting card may contain an image that does not match the particular emotion of the written message, or the placement of the written message relative to the image may be ill-placed such that the intended meaning of the card is lost or lessened. Accordingly, consumers are often forced to accept greeting cards that do not fully convey their message.

In some instances, the consumers may find a powerful image of one greeting card that captures the theme or emotion of a particular occasion, yet find a written message of another greeting card that is more appropriate. In this situation, the consumers may have to purchase two cards in order to express their feelings more adequately.

Currently, custom greeting cards can be created by artists, designers and photographers based on their visual artworks by special ordering cardstocks with their desired messages printed on the cardstocks from wholesale cardstock suppliers. The customized cardstocks with the imprinted messages would then be combined with the visual artworks to create special greeting cards.

However, this approach is also problematic for a number of reasons. First, because the written message is preprinted on the cardstocks, consumers are, again, left with generic generalities rather than having emotionally tailored messages. The approach does not provide the end consumers with the option to select a particular message of their choice and match it with a particular image, or the option to strategically place the personally selected message on a desired location on the card.

Moreover, wholesale cardstock suppliers often require printing custom cardstocks in large quantity batches. Consequently, this results in batches of hundreds or thousands of cards having the same exact message. Further, wholesale cardstock suppliers typically charge additional fees for printing cardstocks in different color fonts or different color sheets. Therefore, consumers are left without a choice on the message to be included in the cards, the placement of the written message relative to card design, or the color of the card and the fonts and styles of the written text.

Based on the foregoing, the prior art is deficient in that it does not fully satisfy the end consumers' needs for personalized social expression items, and the additional costs incurred by the artists, designers and photographers for customizing their special cards get passed down to the end consumers.

### BRIEF SUMMARY OF THE INVENTION

The present invention provides methods for providing personalized social expression items that solve the problems encountered in the prior art discussed above. Unlike the prior art, the various embodiments of the present invention provide consumers with options to mix and match visual artworks on social expression items such as greeting cards or a photo cards with appropriate messages that are suitable for particular occasions. Further, the embodiments of the present invention provide consumers with the freedom to affix the selected messages on any desired locations on the visual artworks.

In the described embodiments herein, messages of sentiment are not preselected by manufacturers of the social expression items and imprinted on the social expression items prior to being offered and sold to consumers. Instead, embodiments of the methods provide consumers with options to choose the type of social expression item, the visual artwork to be incorporated into the social expression item, and the appropriate message to be included in the social expression item. Consumers then receive the physical social expression item containing the selected visual artwork and the desired message imprinted on a self-adhesive label. The consumers can choose the location to affix the label containing the message on the visual artwork and send the social expression item to the intended recipient by mail.

Embodiments of the present invention provide new methods to personalize social expression items that stimulate brain activities, personally engage the sender of the social expression item and provide personal gratification by enabling the sender to fully express the sender's message to the recipient.

### BRIEF DESCRIPTION OF DRAWINGS

FIG. 1 is a diagram of a preferred method for preparing a personalized expression item.

FIG. 2 is a diagram of a preferred method for providing a personalized photo card to a consumer.

FIG. 3 is a diagram of a preferred method for providing a personalized social expression item to a consumer.

FIG. 4 is a front view of a preferred embodiment of the personalized social expression item.

FIG. 5 is a perspective view of the preferred embodiment of the personalized social expression item.

### DETAILED DESCRIPTION OF THE PREFERRED EMBODIMENTS

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

In the described embodiments herein, consumers of social expression items are provided with various options on the types of social expression item (greeting card, note card, calendar, etc.), the visual artworks to be incorporated into the social expression items and the appropriate messages to be included in the social expression items. Subsequently, the consumers are provided with the actual, physical social expression items containing the desired visual artworks and the desired messages imprinted on self-adhesive labels. The consumers then choose the locations to affix the labels containing the messages on the visual artworks, and mail the social expression items to the intended recipients.

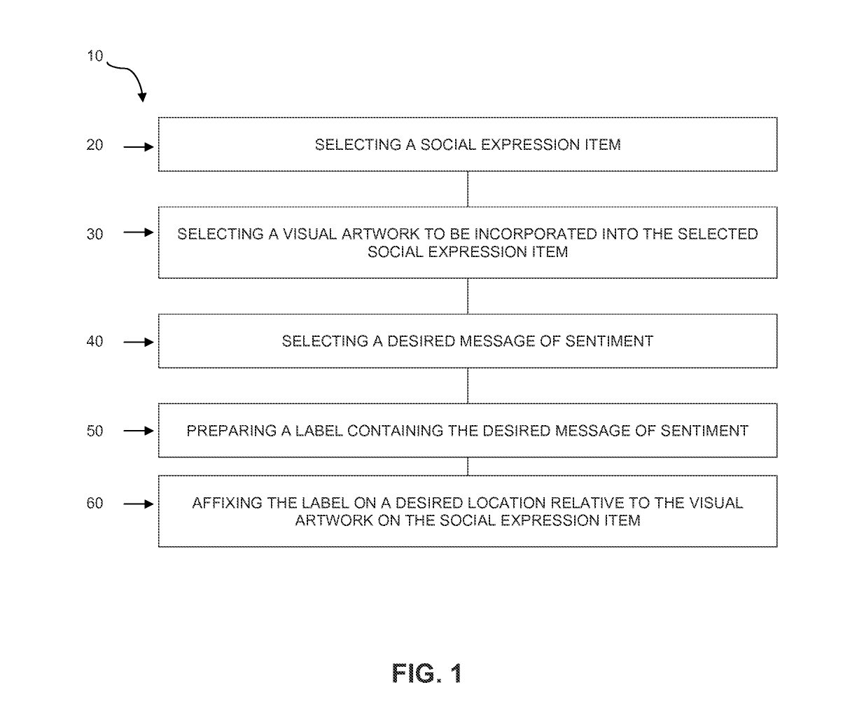

FIG. 1 illustrates a preferred method 10 for preparing a personalized social expression item. The method 10 may comprise a step 20 of selecting a social expression item, a step 30 of selecting a visual artwork to be incorporated into the selected social expression item, a step 40 of selecting a desired message of sentiment, a step 50 of preparing a label containing the desired message of sentiment, and a step 60 of affixing the label on a desired location relative to the visual artwork

The step 20 of selecting a social expression item may comprise selecting a particular physical stationery item or medium such as a greeting card, a notecard, a postcard, a matted photo image, a calendar, a notebook, a notepad, a sticky note or a bookmarker.

The step 30 of selecting a visual artwork to be incorporated into the selected social expression item may comprise selecting a photograph, an altered photo image, a painting, a visual illustration or a drawing which contains images with specific emotional appeal suitable for a particular occasion to be used with the selected social expression item. The selected visual artwork is then incorporated into the selected social expression item. By way of example and not as a limitation, a special greeting card may be prepared by affixing a photograph on the front cover portion of the card.

The step 40 of selecting a desired message of sentiment may include selecting a passage from the Bible, a book, a quote from famous figures, literary excerpt, song lyrics and so forth. The passage selected may cater to a particular occasion, such as an engagement, a wedding, a baptism, a birthday, a loss of a loved one, a graduation, a religious holiday, etc. By way of example and not as a limitation, a particular passage may contain a message of encouragement to get well soon, a congratulatory message on a new job or a blessing to a newly wed. Preferably, the selected message correlates with the overall theme of the selected visual artwork.

The step 50 of preparing a label containing the desired message of sentiment may further comprise providing a self-adhesive label sheet, creating a label template using a computer program, typing the desired passage onto the label template, setting the parameters of the typed passage inside the writing area of the label template, printing the label template containing the passage on the self-adhesive label sheet (e.g., with a printer), and cutting the self-adhesive label sheet into individual label strips. The step of setting the parameters of the typed passage inside the writing area of the label template may further comprise aligning the text of the desired passage to fit inside the writing area of the label template and setting the desired font size, color and style of the text. In another embodiment, the label template may be configured to allow texts to be printed outside the writing area of the label template. This embodiment allows a trademark, a concise instruction or a short text that is not intended to be affixed to the visual artwork to be printed.

According to a preferred embodiment, the suitable self-adhesive label sheet may comprise a writeable surface and a self-adhesive backing, and may comprise any material of any size, color and shape.

In an alternative embodiment, the desired passage may be handwritten on the label sheet directly instead of typed onto the label template on the computer and printed on the label sheet. Preferably, a vegetable byproduct based ink, such as soy based ink with permanent properties, may be used. Alternatively, other suitable types of ink such as pigment ink, dye-based ink, acid free ink, permanent and non-permanent solvent based ink, waterproof ink, and water based dye-ink may also be used.

According to a preferred embodiment, the step of cutting the self-adhesive label sheet into individual label strips may include cutting excess margins from the right side and left side of the label sheet, aligning a space between each label with a cutting edge of a cutter, and slicing the label sheet in the space between each label. This step may be automated or performed manually.

The step 60 of affixing the label on a desired location relative to the visual artwork on the social expression item may further include peeling the self-adhesive backing from the individual label strip and placing the individual label strip either on a bottom of portion of the visual artwork, on a side portion of the visual artwork, or on a top portion of the visual artwork. Further, in an embodiment that uses a greeting card as the social expression item, the step may further include placing the label strip either on a front cover of the greeting card or inside the greeting card.

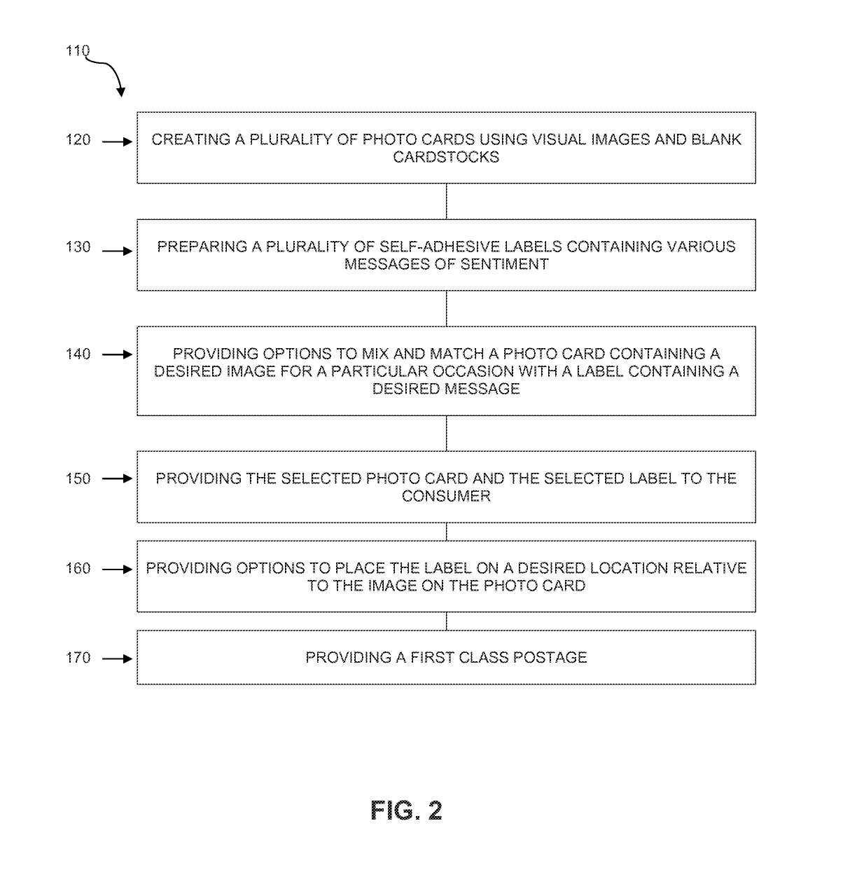

In FIG. 2, a method 110 for providing a personalized photo card to a consumer is provided. The method 110 may comprise a step 120 of creating a plurality of photo cards using visual images, such as photo images, and blank cardstocks, a step 130 of preparing a plurality of self-adhesive labels containing various messages of sentiment, a step 140 of providing options to mix and match a photo card containing a desired image for a particular occasion with a label containing a desired message, a step 150 of providing the selected photo card and the selected label to the consumer, and a step 160 of providing options to place the label on a desired location relative to the image on the photo card. In another preferred embodiment, an additional step 170 of providing a first class postage may be provided for the consumer's convenience.

The step 120 of creating a plurality of photo cards using visual images and blank cardstocks may include placing a visual image such as a photograph, a painting or a drawing on each blank cardstock. This step may comprise gluing the visual image onto the cardstock, creating an insert or a frame pocket in the cardstock to place the visual image, printing the visual image on the cardstock or any other suitable methods of affixing images onto cardstocks. In an embodiment where each photo card includes an outer cover portion and an inner portion, the step 120 may include placing the visual image on the outer cover portion of the photo card and leaving the inner portion of the photo card blank to provide sufficient space for the purchasing consumer to handwrite personal messages.

The step 130 of preparing a plurality of self-adhesive labels containing various messages of sentiment may further comprise selecting a variety of meaningful passages, providing a plurality of blank self-adhesive label sheets, creating a plurality of label templates using a computer program, typing the desired passages onto the label templates, setting the parameters of the typed passages inside the writing areas of the label templates, printing the label templates containing the passages on the self-adhesive label sheets, and cutting the self-adhesive label sheets into individual label strips.

The step of selecting a variety of meaningful passages may include selecting a passage from the Bible, a book, a quote from famous figures, literary excerpt, song lyrics or other sources, that are suitable for particular occasions.

The step of setting the parameters of the typed passages inside the writing areas of the label templates may further comprise aligning the text of the desired passages to fit inside the writing areas of the label templates and setting the desired font size, color and style of the text. In another embodiment, the label template may be configured to allow texts to be printed outside the writing area of the label templates.

Preferably, the suitable self-adhesive label sheets comprise writeable surfaces and self-adhesive backings, and may comprise any material of any size, color and shape.

In an alternative embodiment, the desired passages may be handwritten on the label sheets directly instead of typed onto the label templates and printed on the label sheets. Preferably, a vegetable byproduct based ink, such as soy based ink with permanent properties, may be used. Alternatively, other suitable types of ink such as pigment ink, dye-based ink, acid free ink, permanent and non-permanent solvent based ink, waterproof ink, and water based dye-ink may also be used.

The step of cutting the self-adhesive label sheets into individual label strips may include cutting excess margins from the right side and left side of each label sheet, aligning a space between each label with a cutting edge of a cutter, and slicing each label sheet in the space between each label.

According to a preferred embodiment, the step 140 of providing options to mix and match a photo card containing a desired image for a particular occasion with a label strip containing a desired message may further comprise providing a brick and mortar retail store or an online store wherein the consumer has access to peruse various photo images, passages and quotes, select any desired image and any desired passage, and purchase any combination of an image and a passage that fits the consumer's needs. Alternatively, the consumer may have an option to purchase a plurality of photo cards and a plurality of passages for even greater options to mix and match a photo card with an appropriate passage.

In yet another preferred embodiment, the step 140 may further comprise providing a means to allow the consumer to custom order a personal message or passage to be printed on the self-adhesive label. By way of example and not as a limitation, in an embodiment where the online store is provided, the online store may provide a means for the consumer to submit a request to custom order the personal message, manually type the personal message in a provided space on the website and electronically submit the request with the purchase order online.

The step 150 of providing the selected photo card and the selected passage to the consumer comprises providing a physical photo card containing the selected image and a physical label strip containing the selected passage in a package. According to one embodiment, the package may comprise a clear transparent bag or sleeve that makes its contents visible. In an embodiment wherein an online store is provided, the physical photo card and the physical label strip containing the selected passage may be shipped as a complete package to the consumer. In an embodiment where a mortar and brick retail store is provided, the physical photo card and the physical label strip is provided to the consumer upon completion of the sale transaction.

The step 160 of providing options to position the written passage on any desired location relative to the image on the photo card comprises allowing the consumer to make a personal selection on the location to place the desired passage on the image, peel the backing of the self-adhesive label strip containing the desired passage, and affix the label onto the image on the desired location. By way of example and not as a limitation, a consumer may affix the passage on top of the image, the bottom of the image or the side of the image, and either on the outer cover of the photo card or on the inner portion of the photo card.

The step 170 of providing a first class postage may be provided for the consumer's convenience to obviate the need for the consumer to go to the post office to purchase a stamp to mail the photo card.

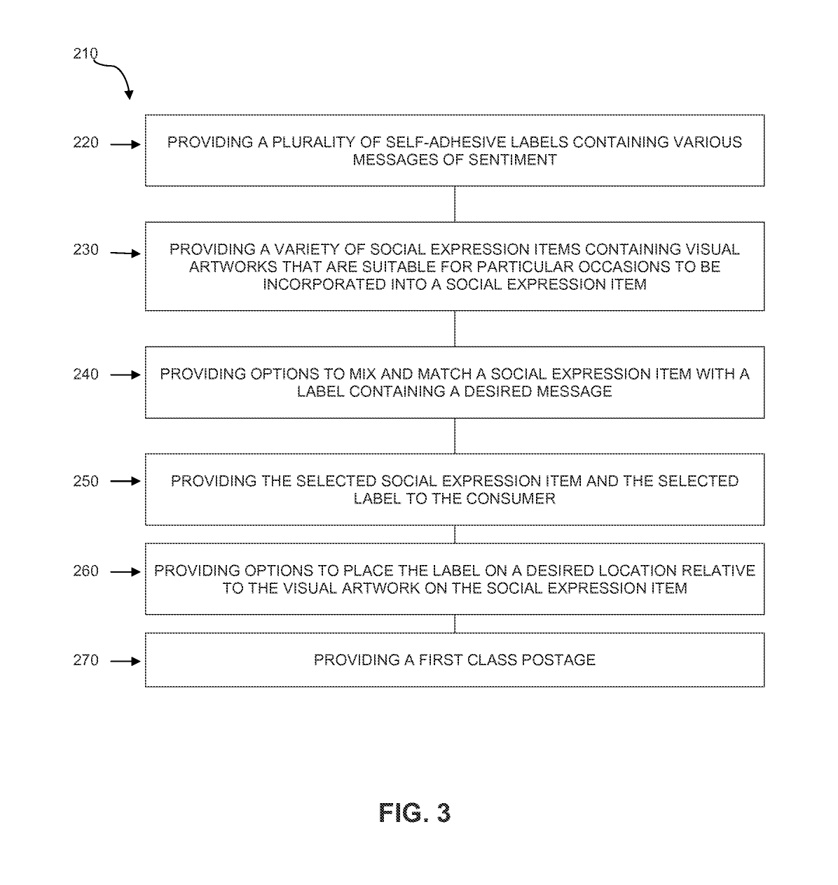

FIG. 3 illustrates a method 210 for providing a personalized social expression item to a consumer. The method 210 may comprise a step 220 of providing a plurality of self-adhesive labels containing various messages of sentiment, a step 230 of providing a variety of social expression items containing visual artworks that are suitable for particular occasions, a step 240 of providing options to mix and match a social expression item with a label containing a desired message, a step 250 of providing the selected social expression item and the selected label to the consumer, and a step 260 of providing options to place the label on a desired location relative to the image on the social expression item. In another preferred embodiment, an additional step 270 of providing a first class postage may be provided for the consumer's convenience.

The step 220 of providing a plurality of self-adhesive labels containing various messages of sentiment may further comprise providing options to select a variety of meaningful passages from the Bible, a book, a quote from famous figures, literary excerpt, song lyrics or other sources that are suitable for particular occasions and placing them on blank self-adhesive labels.

Similar to the embodiments described above, the plurality of self-adhesive labels containing various messages of sentiment may be prepared by providing a plurality of blank self-adhesive label sheets, creating a plurality of label templates using a computer program, typing the desired messages onto the label templates, setting the parameters of the typed passages inside the writing areas of the label templates, printing the label templates containing the passages on the self-adhesive label sheets, and cutting the self-adhesive label sheets into individual label strips.

The step of setting the parameters of the typed messages inside the writing areas of the label templates may further comprise aligning the text of the desired passages to fit inside the writing areas of the label templates and setting the desired font size, color and style of the text. In another embodiment, the label template may be configured to allow texts to be printed outside the writing area of the label templates.

Preferably, the suitable self-adhesive label sheets comprise writeable surfaces and self-adhesive backings, and may comprise any material of any size, color and shape.

In an alternative embodiment, the desired messages may be handwritten on the label sheets directly instead of typed onto the label templates and printed on the label sheets. Preferably, a vegetable byproduct based ink, such as soy based ink with permanent properties, may be used. Alternatively, other suitable types of ink such as pigment ink, dye-based ink, acid free ink, permanent and non-permanent solvent based ink, waterproof ink, and water based dye-ink may also be used.

The step of cutting the self-adhesive label sheets into individual label strips may include cutting excess margins from the right side and left side of each label sheet, aligning a space between each label with a cutting edge of a cutter, and slicing each label sheet in the space between each label.

The step 230 of providing a variety of social expression items containing visual artworks that are suitable for particular occasions to be incorporated into a social expression item may comprise displaying stationery items such as greeting cards, notecards, postcards, photo cards, calendars, notebooks, notepads, sticky notes, bookmarkers, matted photo images, etc. that incorporate preselected visual artworks. By way of example and not as a limitation, suitable visual artworks to be incorporated with the social expression items may include photographs, paintings, visual illustrations or drawings which contain images with specific emotional appeal that are appropriate for particular occasions.

In an alternative preferred embodiment, the provided social expression items may not incorporate preselected visual artworks. Instead, the social expression items are displayed alongside a variety of visual artworks to give the consumer an option to mix and match a desired social expression item with a desired visual artwork for further personalization.

The step 240 of providing options to mix and match the social expression item with a label containing a desired message may further comprise providing a brick and mortar retail store or an online store wherein the social expression items and the various passages are displayed together, and the consumer may select any combination of a social expression item and a desired passage that fits the consumer's needs. Alternatively, the consumer may have the option to purchase a plurality of social expression items and a plurality of labels containing the desired passages for even greater options to mix and match a social expression item with an appropriate passage.

In another preferred embodiment, the step 240 may further comprise providing a means to allow the consumer to custom order a personal message or passage to be printed on the self-adhesive label. By way of example and not as a limitation, in an embodiment where the online store is provided, the online store may provide a means for the consumer to submit a request to custom order the personal message, manually type the personal message in a provided space on the website and electronically submit the request with the purchase order online.

The step 250 of providing the selected social expression item and the selected passage to the consumer comprises providing a physical social expression item containing the selected visual artwork/image and a physical label strip containing the selected passage in a package. In an embodiment wherein an online store is provided, the physical social expression item and the physical label strip containing the selected passage may be shipped as a complete package to the consumer. In an embodiment where a mortar and brick retail store is provided, the physical social expression item and the physical label strip is provided to the consumer upon completion of the sale transaction.

The step 260 of providing options to place the label on a desired location relative to the image on the social expression item comprises allowing the consumer to make a personal selection on the location to place the desired passage on the image, peel the backing of the self-adhesive label strip containing the desired passage, and affix the label onto the image on the desired location. By way of example and not as a limitation, a consumer may affix the passage on a top portion of the image, the bottom of the image or the side of the image.

The step 270 of providing a first class postage may be provided for the consumer's convenience to obviate the need for the consumer to go to the post office to purchase a stamp to mail the social expression item.

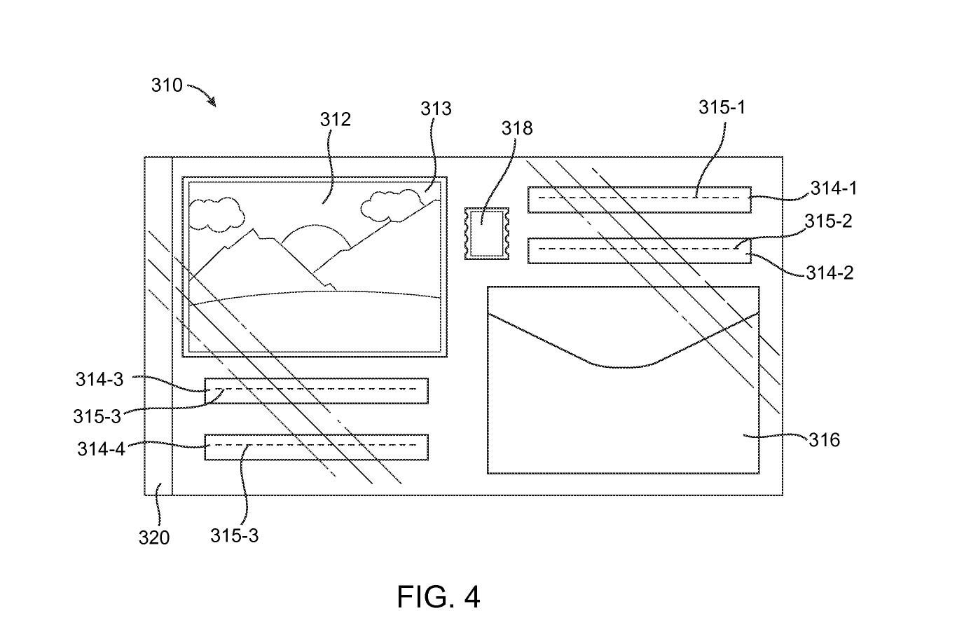

In FIG. 4 a preferred embodiment of a personalized social expression item package is designated by a reference numeral 310. The personalized social expression item package 310 may comprise a social expression item 312 which includes a visual artwork 313, a plurality of self-adhesive textual labels 314 containing various written messages 315, where elements of similar structure are designated by the same reference numerals followed by consecutive numberings such as “−2,” “−3,” “−4” and so forth, an envelope 316 and a stamp 318. Preferably, the personalized social expression item package 310 is contained inside a clear, see through bag or sleeve 320. The personalized social expression item 310 may be sold at online stores or retail brick and mortar stores.

According to a preferred embodiment, the social expression item 312 may further comprise a greeting card, a notecard, a postcard, a photo card, a calendar, a notebook, a matted photo image, a notepad, sticky notes, a bookmarker or any other stationary item. The visual artwork 313 to be included in the social expression item 312 may comprise a photograph, a painting, a drawing or any desired visual image, graphic design or illustration. In one preferred embodiment, a consumer may personally mix and match the desired social expression item 312 with the desired visual artwork 313. In another embodiment, the consumer may choose the desired social expression item 312 from variety of social expression items 312 containing preselected visual artworks 313.

The various written messages 315 may be selected from a variety of meaningful passages from the Bible, a book, a quote from famous figures, literary excerpt, song lyrics or other sources that are suitable for particular occasions. In one embodiment, the various messages 315 may be prepared and provided to the consumer for his/her personal selection. In another embodiment, the consumer may write the desired messages 315 directly onto blank self-adhesive labels 314 provided with the package 310. In an embodiment where the online store is provided, the online store may provide a means for the consumer to submit a request to custom order the personalized message 315, manually type the personalized message 315 in a provided space on the website and electronically submit the request with the purchase order online.

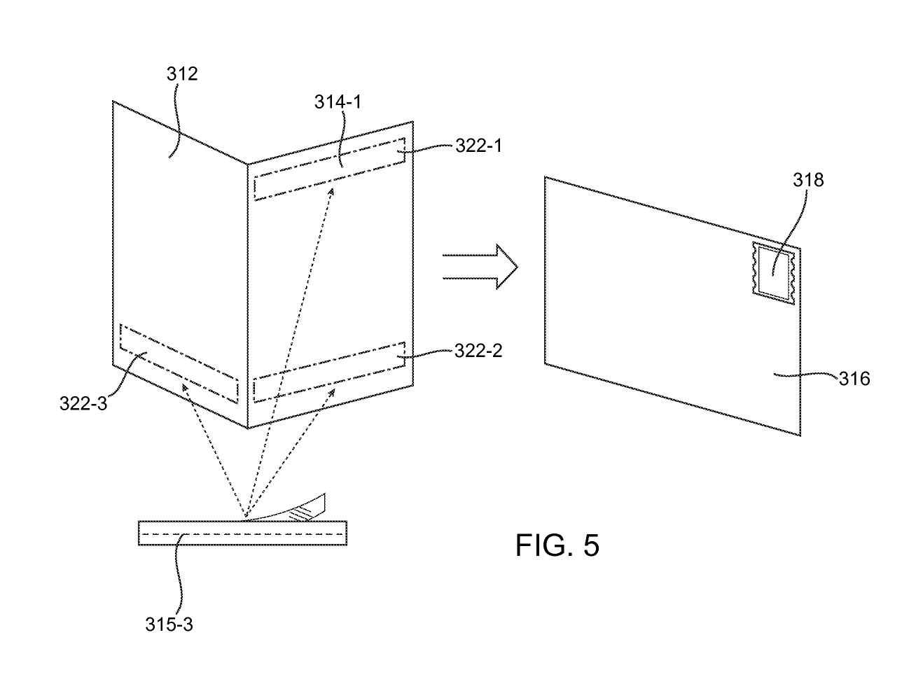

FIG. 5 illustrates a preferred principle of operation of the personalized social expression item 310. Upon receiving the personalized social expression item package 310, the consumer may choose a desired location 322 on the social expression item 312 to place the desired written message 315, peel a backing 317 from the self-adhesive text label 314, and stick the self-adhesive text label 314 on the desired location 322. By way of example and not as a limitation, various possible desired locations 322-1, 322-2, 322-3 are illustrated. It is to be understood that in an embodiment where a plurality of messages 315 are desired, the consumer may place multiple textual labels 314 on a single social expression item 312 at different locations 322-1, 322-2, 322-3. The consumer then places the social expression item 312 inside the envelope 316 and mails the sealed envelope 316 with the stamp 318, which may comprise a forever postage stamp, to the intended recipient.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for preparing a personalized social expression item, comprising:
selecting a social expression item;
selecting a visual artwork to be incorporated into the selected social expression item;
selecting a desired message of sentiment;
preparing a label containing the desired message of sentiment; and
affixing the label on a desired location relative to the visual artwork on the social expression item.

2. The method of claim 1, wherein the step of selecting a social expression item further comprises selecting a particular stationery item such as a greeting card, a notecard, a postcard, a matted photo image, a calendar, a notebook, a notepad, a sticky note or a bookmarker.

3. The method of claim 1, wherein the step of selecting a visual artwork to be incorporated into the selected social expression item further comprises:
selecting a photograph, a painting, a visual illustration or a drawing which contains images with specific emotional appeal suitable for a particular occasion to be used with the selected social expression item.

4. The method of claim 1, wherein the step of selecting a desired message of sentiment further comprises selecting a message from the Bible, a book, a quote from famous figures, literary excerpt, or song lyrics for a particular occasion.

5. The method of claim 1, wherein the step of selecting a desired message of sentiment further comprises:
providing a self-adhesive label sheet;
creating a label template using a computer program;
typing the desired message onto the label template;
setting the parameters of the typed message inside the writing area of the label template, including aligning the text of the desired message to fit inside the writing area of the label template and setting the desired font size, color and style of the text;
printing the label template containing the message on the self-adhesive label sheet; and
cutting the self-adhesive label sheet into individual label strips.

6. The method of claim 5, wherein the step of affixing the label on a desired location relative to the visual artwork on the social expression item further comprises:
peeling the self-adhesive backing from the individual label strip; and
placing the individual label strip either on a bottom portion of the visual artwork, on a side portion of the visual artwork, on a top portion of the visual artwork, anywhere inside the card or on the back of the card.

7. A method for providing a personalized photo card to a consumer, comprising:
creating a plurality of photo cards using visual images and blank cardstocks;
preparing a plurality of self-adhesive labels containing various messages of sentiment;
providing options to mix and match a photo card containing a desired image for a particular occasion with a label containing a desired message;
providing the selected photo card and the selected label to the consumer; and
providing options to place the label on a desired location relative to the image on the photo card.

8. The method of claim 7, wherein the step of affixing the label on a desired location relative to the visual artwork on the social expression item further comprises placing a visual image such as a photograph, a painting or a drawing on each blank cardstock by gluing the visual image onto the cardstock, creating an insert or a frame pocket in the cardstock to place the visual image or printing the visual image on the cardstock.

9. The method of claim 7, wherein step of preparing a plurality of self-adhesive labels containing various messages of sentiment further comprises:
selecting a variety of meaningful messages;
providing a plurality of blank self-adhesive label sheets;
creating a plurality of label templates using a computer program;
typing the desired messages onto the label templates;
setting the parameters of the typed messages inside the writing areas of the label templates;
printing the label templates containing the messages on the self-adhesive label sheets; and
cutting the self-adhesive label sheets into individual label strips.

10. The method of claim 7, wherein the step of providing options to mix and match a photo card containing a desired image for a particular occasion with a label containing a desired message further comprises:
providing a venue wherein the consumer has access to select various photo images, messages and quotes prior to purchasing, and purchase any combination of a photo image and a message.

11. The method of 10, wherein the venue is an online store.

12. The method of claim 7, wherein the step of providing the selected photo card and the selected label to the consumer further comprises providing a physical photo card containing the selected image and a physical label strip containing the selected message in a package.

13. The method of claim 7, wherein the step of providing options to place the label on a desired location relative to the image on the photo card further comprises:
allowing the consumer to make a personal selection on the location to place the desired message relative to the image, peel the backing of the self-adhesive label strip containing the desired message, and affix the label relative to the image on the desired location.

14. A method for providing a personalized social expression item to a consumer, comprising:
providing a plurality of self-adhesive labels containing various messages of sentiment;
providing a variety of social expression items;
providing a variety of visual artworks that are suitable for particular occasions to be incorporated into a social expression item;
providing options to mix and match the social expression item with a label containing a desired message;
providing the selected social expression item and the selected label to the consumer; and
providing options to place the label on a desired location relative to the visual artwork on the social expression item.

15. The method of claim 14, wherein the step of providing a plurality of self-adhesive labels containing various messages of sentiment further comprises:
providing options to select a variety of meaningful messages to the consumer; and
placing the messages on blank self-adhesive labels.

16. The method of claim 14, wherein the step of providing a variety of social expression items further comprises displaying stationery items such as greeting cards, notecards, postcards, photo cards, calendars, notebooks, notepads, sticky notes or bookmarkers for sale.

17. The method of claim 14, wherein the step of providing a variety of visual artworks that are suitable for particular occasions to be incorporated into a social expression item further comprises:
displaying a variety of photographs, paintings, visual illustrations or drawings which contain images with specific emotional appeal that are appropriate for particular occasions, along with the variety of social expression items; and
providing options to mix and match a desired social expression item and a desired visual artwork.

18. The method of claim 14, wherein the step of providing options to mix and match the social expression item with a label containing a desired message further comprises:
providing a venue wherein the social expression items and the various messages are displayed together, and the consumer may select any combination of a social expression item and a desired message that fits the consumer's needs.

19. The method of claim 14, wherein the step of providing the selected social expression item and the selected label to the consumer further comprises providing the physical social expression item containing the selected visual artwork and the physical label strip containing the selected message in a package.

20. The method of claim 14, wherein the step of providing options to place the label on a desired location relative to the visual artwork on the social expression item further comprises allowing the consumer to make a personal selection on a location to place the desired message on the image, peel the backing of the self-adhesive label strip containing the desired message, and affix the label relative to the image on the desired location.
